(19) United States
(12) Patent Application Publication
(10) Pub. No.: US 2025/0070598 A1
(43) Pub. Date: Feb. 27, 2025

(54) Intermediate Passive Wireless Loop Coil and Methods of Use Thereof

(71) Applicant: Texas Tech University System, Lubbock, TX (US)

(72) Inventors: Bashir Igbal Morshed, Lubbock, TX (US); Mahfuzur Rahman, Lubbock, TX (US)

(21) Appl. No.: 18/726,209

(22) PCT Filed: Jan. 3, 2023
(86) PCT No.: PCT/US2023/060019

§ 371 Date: Jul. 2, 2024

Related U.S. Application Data
(60) Provisional application No. 63/296,065, filed on Jan. 3, 2022.

(51) Int. Cl. H02J 50/10; H02J 50/40; H02J 50/50

(52) U.S. Cl. CPC H02J 50/10; H02J 50/40; H02J 50/50

(57) ABSTRACT

An intermediate passive wireless loop circuit includes one or more first loop coils, one or more second loop coils, and a set of interconnecting wires that series or parallel connect the one or more first loop coils to the one or more second loop coils such that the one or more first loop coils are separated from the one or more second loop coils by a distance.

### CROSS-REFERENCE TO RELATED APPLICATIONS

This application claims priority to U.S. Provisional Application Ser. No. 63/296,065, filed Jan. 3, 2022, the entire contents of which are incorporated herein by reference.

### STATEMENT OF FEDERALLY FUNDED RESEARCH

This invention was made with government support under Grant Nos. CNS-1932281 and 2105766 awarded by the National Science Foundation. The government has certain rights in the invention.

### TECHNICAL FIELD OF THE INVENTION

The present invention relates in general to the field of wireless power transfer, and more particularly, to a method and apparatus for increasing a range of inductively coupled wireless power transfer using an intermediate passive wireless loop coil.

### BACKGROUND OF THE INVENTION

Without limiting the scope of the invention, its background is described in connection with wireless power transfer.

Wireless power transfer (WPT) system is a way to transfer power from a transmitter (Tx) to a receiver (Rx) without using a wired connection. WPT is proved to be advantageous where using the wired connection is not feasible, hazardous, or inconvenient. There are several technological options for WPT, such as inductive coupling (ICp), magnetic coupling (MCp), microwave, and laser radiation. All of these techniques have different power levels, working frequency, transfer distance, size and forming factors that are preferred by a certain specific application over the others. Using far field, microwave and laser radiation can transfer power over meters or hundreds of meters, but the power level is relatively small in order to avoid hazardous radiation [1]-[2]. On the contrary, the ICp and MCp use near field. Although the transfer distance is usually limited to a range of centimeters, while the transferred power can reach to a level of tens of kilowatts. Inductive coupling is one of the most common types of WPT. The inductive coupling systems typically work in the kilohertz band are also usually tuned to resonance by using external capacitors [3]-[4]. As the ICp technique uses low frequency non-radiative near field, it is suitable to use in devices placed near human [5]. As a result, this technique is advantageous to wearable devices. The ICp based WPT system has gained popularity in different body-worn sensors and devices and as well as, medically implanted devices [6]-[8]. Moreover, wireless charging for smartphones is already available commercially. For instance, Qi charging based solution is now available which provides the way to charge smartphones wirelessly [9]-[10]. Also, power transfer for electric vehicle using WPT is being investigated to remove the need of already available wired charging system [11]-[12].

In many cases, the WPT system uses planar spiral coil (PSC) based design for the Tx and Rx side coils [13]. By implementing the PSC, both the Tx and the Rx side coil can gain thin profile. Because of the spiral structure, the magnetic flux is concentrated on the center of the structure. To minimize the effect of leakage flux, the Rx coil is placed coaxially with respect to the Tx coil. The amount of magnetic flux is reduced by the cube of the distance as the coils are separated further. Also, the power transfer decreases by the square of 60 dB per decade. Hence, the Tx and Rx coils are typically placed less than one inch apart. This leads to many practical problems, for example, a table with integrated wireless charging capability requires phones to be placed at a certain position, electric car with wireless charge capability to be parked directly over the transmitter coil, or wearable devices cannot be charged while worn. In another example, such as an implanted deep brain stimulator, the Tx and Rx coils may need to be placed further away.

Many groups have been conducting investigations to resolve the limitations associated with shorter distance by using multiple coils with larger coil size or using ferromagnetic materials [13]-[14].

According there is a need for an apparatus, system and method to extend the WPT range.

### SUMMARY OF THE INVENTION

Various embodiments of the present invention provide devices, methods and systems for increasing the WPT range by implementing wireless passive loop coils. Two coils are connected in series or parallel. One end of the loop coil is placed on the Tx coil and the other end of the series connected loop coil is placed on top or bottom of the Rx coil. In another setup, three loop coils were connected in series and investigated for efficiency performance. The coils have been investigated with different coil diameters (22, 26 and 28 gauge) and number of turns (7, 9 and 11 turns). The present invention is not limited to these coil diameters or number of turns. Other coil diameters and number of turns can be used. Although the examples disclosed herein use a Qi charging based solution, the present invention is not limited to Qi charging.

In one embodiment, an intermediate passive wireless loop circuit includes one or more first loop coils, one or more second loop coils, and a set of interconnecting wires that series or parallel connect the one or more first loop coils to the one or more second loop coils such that the one or more first loop coils are separated from the one or more second loop coils by a distance.

In one aspect, the one or more first loop coils comprise one or more transmitter loop coils, and the one or more second loop coils comprise one or more receiver loop coils. In another aspect, a diameter of the one or more first loop coils or the one or more second loop coils are of the same size or different sizes. In another aspect, a number of turns of the one or more first loop coils or the one or more second loop coils comprises any number of turns. In another aspect, one or more tuning capacitors are connected to each of the one or more first loop coils and the one or more second loop coils. In another aspect, the one or more first loop coils or the one or more second loop coils power a device; or the one or more first loop coils or the one or more second loop coils charge a battery or energy storage element of the device. In another aspect, the device comprises a phone, a handheld device, a watch, a wearable device, a tablet, a computer, an instrument, a sensor, a consumer electronic product, a physical implant, or an autonomous electric vehicle.

In another embodiment, a method for extending a range of a passive wireless loop circuit includes placing one or more first loop coils approximately above or below one or more transmitter coils of the passive wireless loop circuit, placing one or more second loop coils approximately below or above one or more receiver coils of a device, and wherein a set of interconnecting wires series or parallel connect the one or more first loop coils to the one or more second loop coils such that the one or more first loop coils are separated from the one or more second loop coils by a distance.

In one aspect, the one or more first loop coils comprise one or more transmitter loop coils, and the one or more second loop coils comprise one or more receiver loop coils. In another aspect, a diameter of the one or more first loop coils or the one or more second loop coils are of the same size or different sizes. In another aspect, a number of turns of the one or more first loop coils or the one or more second loop coils comprises any number of turns. In another aspect, one or more tuning capacitors are connected to each of the one or more first loop coils and the one or more second loop coils. In another aspect, the method couples one or more wireless transmitter circuits to the one or more transmitter coils, and couples one or more wireless receiver circuits to the one or more receiver coils. In another aspect, the method powers the device using the one or more second loops coils; or charges a battery or energy storage element of the device using the one or more second loop coils. In another aspect, a wireless transmitter circuit is coupled to the transmitter coil, and a wireless receiver circuit is coupled to the receiver coil. In another aspect, the device comprises a phone, a handheld device, a watch, a wearable device, a tablet, a computer, an instrument, a sensor, a consumer electronic product, a physical implant, or an autonomous electric vehicle.

In another embodiment, a system includes one or more transmitter coils, one or more first loop coils approximately above or below the one or more transmitter coils, one or more receiver coils, one or more second loop coils approximately below or above the one or more receiver coils, and a set of interconnecting wires that series or parallel connect the one or more first loop coils to the one or more second loop coils such that the one or more first loop coils are separated from the one or more second loop coils by a distance.

In one aspect, the one or more first loop coils comprise one or more transmitter loop coils, and the one or more second loop coils comprise one or more receiver loop coils. In another aspect, a diameter of the one or more first loop coils or the one or more second loop coils are of the same size or different sizes. In another aspect, a number of turns of the one or more first loop coils or the one or more second loop coils comprises any number of turns. In another aspect, one or more tuning capacitors are connected to each of the one or more first loop coils and the one or more second loop coils. In another aspect, the one or more second loop coils power a device; or the one or more second loop coils charge a battery or energy storage element of the device. In another aspect, the wireless receiver circuit is coupled to a battery of a a phone, a handheld device, a watch, a wearable device, a tablet, a computer, an instrument, a sensor, a consumer electronic product, a physical implant, or an autonomous electric vehicle. In another aspect, one or more wireless transmitter circuits are coupled to the one or more transmitter coils, and one or more wireless receiver circuits are coupled to the one or more receiver coils. In another aspect, the wireless receiver circuit is coupled to a battery or energy storage element of the device.

In another embodiment of the present invention, a method for fabricating an intermediate passive wireless loop circuit includes: depositing a first conductive layer on a substrate, wherein the first conductive layer comprises a first loop coil having a center point and an exterior point, a second loop coil having a center point and an exterior point, a first interconnecting wire connecting the exterior point of the first loop coil to the exterior point of the second loop coil, and the first loop coil is separated from the second loop coil by a distance; depositing an insulation layer over a portion of the first loop coil and a portion of the second loop coil; and depositing a second conductive layer on the insulation layer and a portion of the substrate, wherein the second conductive layer comprises a second interconnecting wire connecting the center point of the first loop coil to the center point of the second first loop coil.

In one aspect, the method is performed using an Inkjet printer. In another aspect, the substrate is flexible. In another aspect, the method further comprises curing the first conductive layer; curing the insulation layer; and curing the second conductive layer. In another aspect, the method further comprises depositing a protective layer over the first conductive layer, the insulation layer or the second conductive layer. In another aspect, a trace for the first and second conductive layers is approximately 1 mm wide with a gap of approximately 1 mm between adjacent traces. In another aspect, the insulation layer comprises one or more coatings of an insulation material. In another aspect, the method further comprises curing the insulation layer after each deposit of the one or more coatings of the insulation material. In another aspect, the intermediate passive wireless loop circuit has a thickness of less than 50 μm.

In another embodiment of the present invention, an intermediate passive wireless loop circuit fabricated in accordance with the method described above.

Note that the invention is not limited to the embodiments, instead it has the applicability beyond the embodiments herein. The brief and detailed descriptions of this invention are given in the following.

### BRIEF DESCRIPTION OF THE DRAWINGS

For a more complete understanding of the features and advantages of the present invention, reference is now made to the detailed description of the invention along with the accompanying figures and in which:

FIG. 1 is a diagram of a WPT setup where the Tx and Rx coils are place on top of one another in accordance with the prior art;

FIG. 2 is a diagram of a WPT range extension setup where intermediate passive wireless loop coils (LC1 and LC2) allow a large separating of the Tx and Rx coils in accordance with one embodiment of the present invention:

FIG. 3 is an image of the experimental setup in accordance with one embodiment of the present invention:

FIG. 4 is a schematic diagram of the experimental setup shown in FIG. 3;

FIG. 5 is an image of the experimental setup in accordance with another embodiment of the present invention;

FIG. 6 is an image of the experimental setup in accordance with another embodiment of the present invention;

FIG. 7 is a schematic diagram of the experimental setup shown in FIG. 6;

FIG. 8 is an image of the experimental setup in accordance with another embodiment of the present invention:

FIG. 9 is a graph showing output voltage and current achieved for traditional and proposed setups in accordance with one embodiment of the present invention:

FIG. 10 is a graph showing the performance of the proposed setup with different coil size and number of turns in accordance with one embodiment of the present invention:

FIG. 11 is Table I showing the performance of the proposed setup in terms of efficiency for different coil diameters and number of turns in accordance with one embodiment of the present invention:

FIG. 12 is Table II showing the performance comparison for three passive loop coils connected in series in accordance with another embodiment of the present invention:

FIG. 13 is Table III showing the comparison for three passive loop coils connected in series in accordance with another embodiment of the present invention:

FIG. 14 shows the oscilloscope output, where Vavg1, Vavg2, Vavg3, Vavg4 is voltage across Tx side, 100Ω (Tx side), Rx side and lipo charger respectively in accordance with one embodiment of the present invention:

FIG. 15 represents one of the tuning processes where three capacitors 47 nF, 4.7 nF and 10 nF were connected in parallel to tune the proposed loop coil to 140 kHz in accordance with one embodiment of the present invention:

FIG. 16 is a flow chart of a method for extending a range of a passive wireless loop circuit in accordance with one embodiment of the present invention:

FIG. 17A depicts an Inkjet fabrication process in accordance with one embodiment of the present invention:

FIG. 17B depicts the multilayer Injet fabrication in accordance with one embodiment of the present invention:

FIG. 18A is a photograph of two ILP loop coils and on PI film in accordance with one embodiment of the present invention:

FIG. 18B is a photograph showing a rolled up IJP loop coils showing flexibility in accordance with one embodiment of the present invention:

FIG. 18C is a microscope image showing details of the two IJP Ag layers and the insulation IJP PVP layer in between the two Ag layers in accordance with one embodiment of the present invention:

FIG. 19A plots the results of power transfer for a coils with LC1=8 turns and LC2=8 turns in accordance with one embodiment of the present invention:

FIG. 19B plots the results of power transfer for a coils with LC1=10 turns and LC2=8 turns in accordance with one embodiment of the present invention:

FIG. 20 is a flow chart of a method for printing a passive wireless loop circuit in accordance with one embodiment of the present invention; and FIGS. 21-37 depict other data in accordance with the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity but include the general class of which a specific example may be used for illustration. The terminology herein is used to describe specific embodiments of the invention, but their usage does not limit the invention, except as outlined in the claims.

Various methods are described below to provide an example of each claimed embodiment. They do not limit any claimed embodiment. Any claimed embodiment may cover methods that are different from those described above and below. The drawings and descriptions are for illustrative, rather than restrictive, purposes.

Now referring to FIG. 1, a diagram of a WPT setup 100 in accordance with the prior art is shown. Tx coil 102 is connected to a wireless Tx circuit 104, a Rx coil 106 is connected to a wireless Rx Load 108, and the Tx coil 102 is placed on top of the Rx coil 106 with no separation between them. Note that the Rx coil 106 can be placed on top of the Tx coil 102. The output current in the receiving side can be expressed as follows:

$${B}_{T x} ∝ {i}_{Tx}$$

$${ϕ}_{R x} = \int ( {B}_{T x} ) dS$$

$${i}_{R x} = {N}_{R x} * {ϕ}_{R x} / {L}_{R x} ∝ {N}_{R x} * \int ( {i}_{T x} ) dS / {L}_{R x}$$

where: B_{Tx} is the magnetic flux density of Qi Tx:
i_{Tx}, i_{Rx} are the current through Tx and Rx;
ϕ_{Rx} is the magnetic flux in Rx;
L_{Rx} is the inductance of Rx; and
N_{Rx} is the number of turns for Rx.

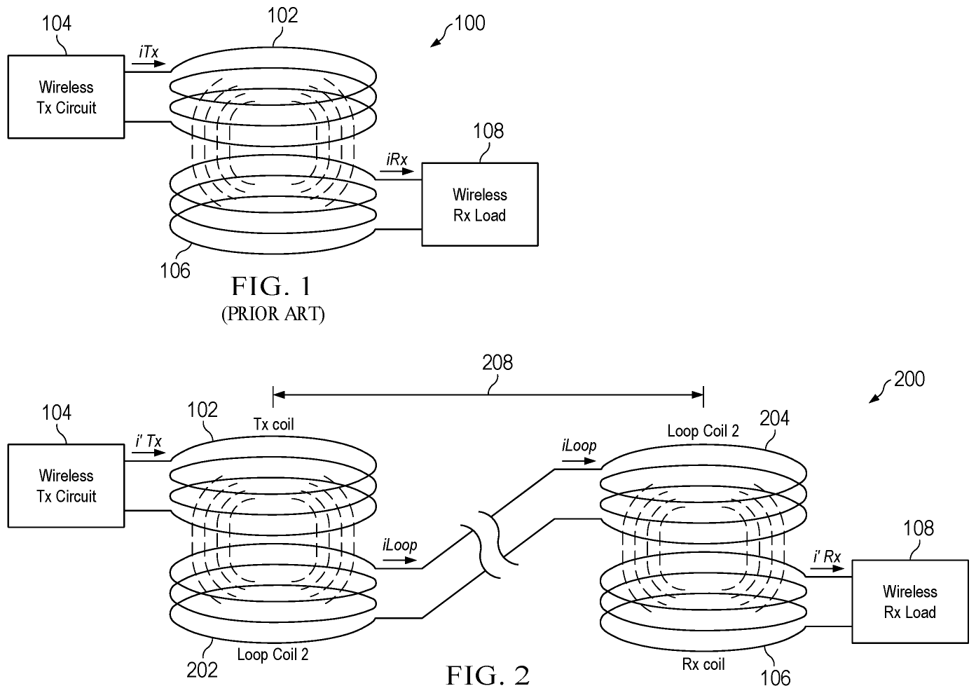

In contrast, FIG. 2 is a diagram of a WPT range extension setup 200 in accordance with one embodiment of the present invention. One or more first passive coils 202 and one or more second passive coils 204 are connected in series, and are placed in between the Qi Tx coil 102 and Rx coil 106, respectively. Note that the one or more first passive coils 202 and one or more second passive coils 204 can be connected in parallel. As shown, the Tx coil 102 is above the one or more first passive coils 202 (Loop Coil 1 or LC1), and the one or more second passive coils 204 (Loop Coil 2 or LC2) are above the Rx coil 106. Note that the Tx coil 102 can be below the one or more first passive coils 202 (Loop Coil 1 or LC1), and the one or more second passive coils 204 (Loop Coil 2 or LC2) can be below the Rx coil 106. The coupling equation for the proposed loop coils is:

$${B}_{T x} ∝ {i}_{Tx}^{′}$$

$${ϕ}_{L C 1} = \int ( {B}_{T x} ) dS$$

$${i}_{L o o p} = {N}_{L c 1} * {ϕ}_{L C 1} / {L}_{L C 1}$$

$${B}_{L C 2} ∝ {i}_{L o o p}$$

$${ϕ}_{R x} = \int ( {B}_{L C 2} ) dS$$

$${i}_{Rx}^{′} = {N}_{R x} * {ϕ}_{R x} / {L}_{R x}$$

$${i}_{Rx}^{′} = {N}_{R x} * \int ( {B}_{L C 2} ) dS / {L}_{R x} ∝ {N}_{R x} * \int ( ( {N}_{L C 1} * \int ( {i}_{Tx}^{′} ) dS ) / {L}_{L C 1} ) dS / {L}_{R x}$$

where: B_{Tx} and B_{LC2} are the magnetic flux density of Qi Tx and LC2;
i_{Tx}, i_{Rx}, i_{Loop} are the current through Tx, Rx, and the loop circuit;
i′_{Tx}, i′_{Rx} are the current through Tx, Rx of proposed setup;
ϕ_{Rx}, ϕ_{LC1} are the magnetic flux in Rx and LC1;
L_{Rx}, L_{LC1} are the inductance of Rx and LC1; and
N_{Rx}, N_{LC1} are the number of turns for Rx and LC1.

The overall efficiency of the proposed method is, η′=η_{LC1}*η_{LC2}, where, η_{LC1} and η_{LC2} are the efficiency for LC1 and LC2, respectively. This equation suggests that the expected efficiency on the Rx side for proposed setup will be somewhat less than the traditional setup.

In one embodiment, an intermediate passive wireless loop circuit includes one or more first loop coils 202, one or more second loop coils 204, and a set of interconnecting wires 206 that series or parallel connect the one or more first loop coils 202 to the one or more second loop coils 204 such that the one or more first loop coils 202 are separated from the one or more second loop coils 204 by a distance 208. As demonstrated, the distance can be 10 inches or more.

In one aspect, the one or more first loop coils 202 comprise one or more transmitter loop coils, and the one or more second loop coils 204 comprise one or more receiver loop coils. In another aspect, a diameter of the one or more first loop coils 202 or the one or more second loop coils 204 are of the same size or different sizes (e.g., 22, 26, 28 AWG or any other AWG). In another aspect, a number of turns of the one or more first loop coils 202 or the one or more second loop coils 204 comprises any number of turns (e.g., 7, 9, 11, or any other number of turns). In another aspect, one or more tuning capacitors are connected to each of the one or more first loop coils 202 and the one or more second loop coils 204. In another aspect, the one or more first loop coils or the one or more second loop coils power a device; or the one or more first loop coils or the one or more second loop coils charge a battery or energy storage element of the device. In another aspect, the device can be a phone, a handheld device, a watch, a wearable device, a tablet, a computer, an instrument, a sensor, a consumer electronic product, a physical implant, an autonomous electric vehicle, or anything containing a battery or energy storage element or capable of being powered by the present invention.

In another embodiment, a system 200 includes one or more transmitter coils 102, one or more first loop coils 202 approximately above or below the one or more transmitter coils 102, one or more receiver coils 106, one or more second loop coils 204 approximately below or above the one or more receiver coils 106, and a set of interconnecting wires 206 that series or parallel connect the one or more first loop coils 202 to the one or more second loop coils 204 such that the one or more first loop coils 202 are separated from the one or more second loop coils 204 by a distance 208.

In one aspect, the one or more first loop coils 202 comprise one or more transmitter loop coils, and the one or more second loop coils 204 comprise one or more receiver loop coils. In another aspect, a diameter of the one or more first loop coils 202 or the one or more second loop coils 204 are of the same size or different sizes (e.g., 22, 26, 28 AWG or any other AWG). In another aspect, a number of turns of the one or more first loop coils 202 or the one or more second loop coils 204 comprises an number of turns (e.g., 7, 9, 11, or any other number of turns). The present invention is not limited to these coil diameters or number of turns. Other coil diameters and number of turns can be used. In another aspect, one or more tuning capacitors are connected to each of the one or more first loop coils 202 and the one or more second loop coils 204. In another aspect, the one or more second loop coils power a device; or the one or more second loop coils charge a battery or energy storage element of the device. In another aspect, the device comprises a phone, a handheld device, a watch, a wearable device, a tablet, a computer, an instrument, a sensor, a consumer electronic product, a physical implant, an autonomous electric vehicle, or anything containing a battery or energy storage element or capable of being powered by the present invention. In another aspect, one or more wireless transmitter circuits 104 are coupled to the one or more transmitter coils 102, and one or more wireless receiver circuits 108 is coupled to the one or more receiver coils 106. In another aspect, the wireless receiver circuit 108 is coupled to a battery of a device.

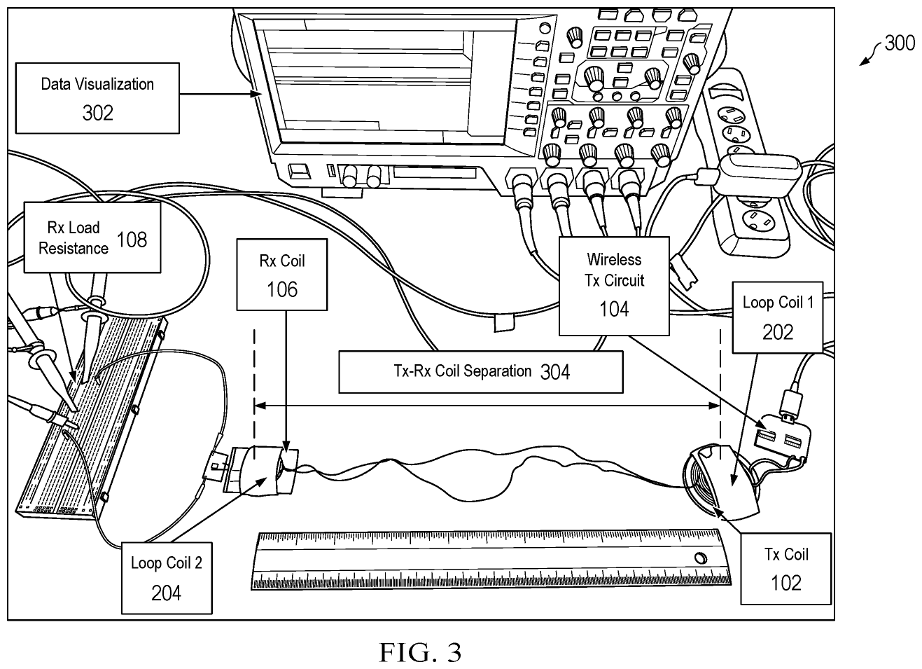

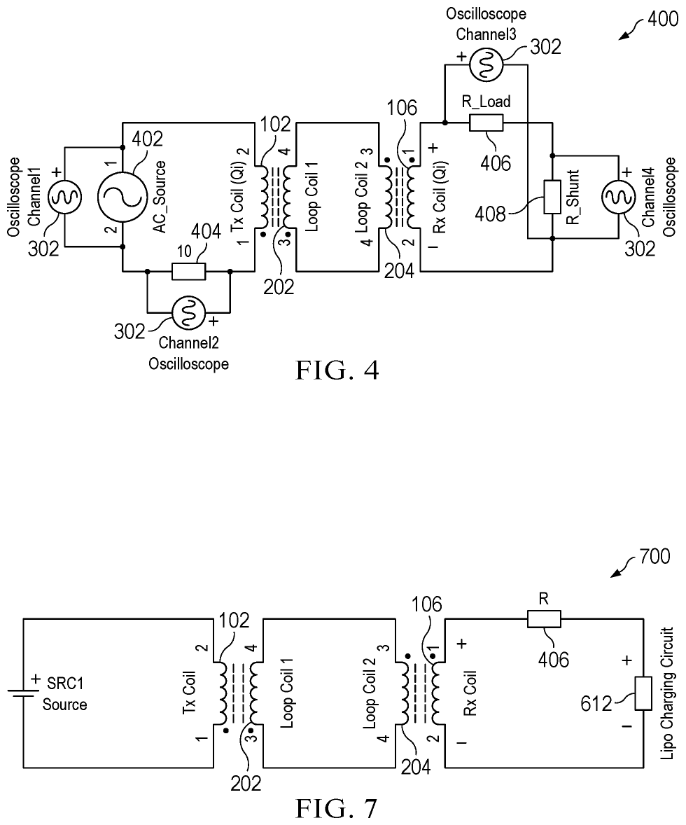

Referring now to FIGS. 3 and 4, an image of the experimental setup 300 and a schematic of the experimental setup 400 in accordance with one embodiment of the present invention are shown. The experimental setup 300 uses a commercial Qi charging system from GeekFun (Model: EK1854) and includes an AC Source 402 and an Oscilloscope 302. The interconnecting wires 304 between the one or more first passive coils 202 and the one or more second passive coils 204 can be of any length. The one or more first passive coils (LC1) 202 are placed on top of the Tx coil 102, and the one or more second passive coils (LC2) 204 are placed on top of the Rx coil 106. A breadboard setup 108 was used to put on the Rx load 406. In the Rx side, the nominal load resistor 406 is connected in series with a shunt resistor, which is always kept 1% of the nominal load resistance. The operating frequency is approximately 140 kHz. The voltages across the AC Source 402, resistor 404, load resistor 406 and shunt resistor 408 are observed using a Keysight oscilloscope (Model: KT-DSOX1204G-InfiniiVision 1000 X-Series Oscilloscope) 302 via Channels 1, 2, 3 and 4, respectively. To calculate the current through the Rx side, the voltage across the shunt resistor is taken into account. The diameter of the wire is measured in inches using the following formula, D=0.005*0.92^{((36-AWG)/39)} where I) is the wire diameter in inches and AWG is the specific AWG value of the wire. To calculate the efficiency, the power from the Tx side is compared with the power achieved at the Rx side.

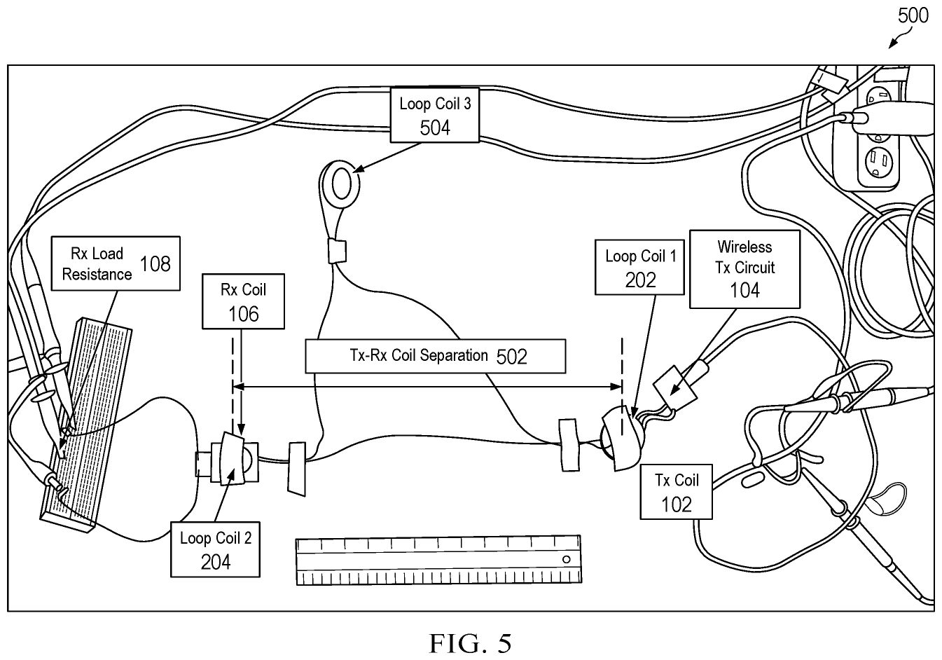

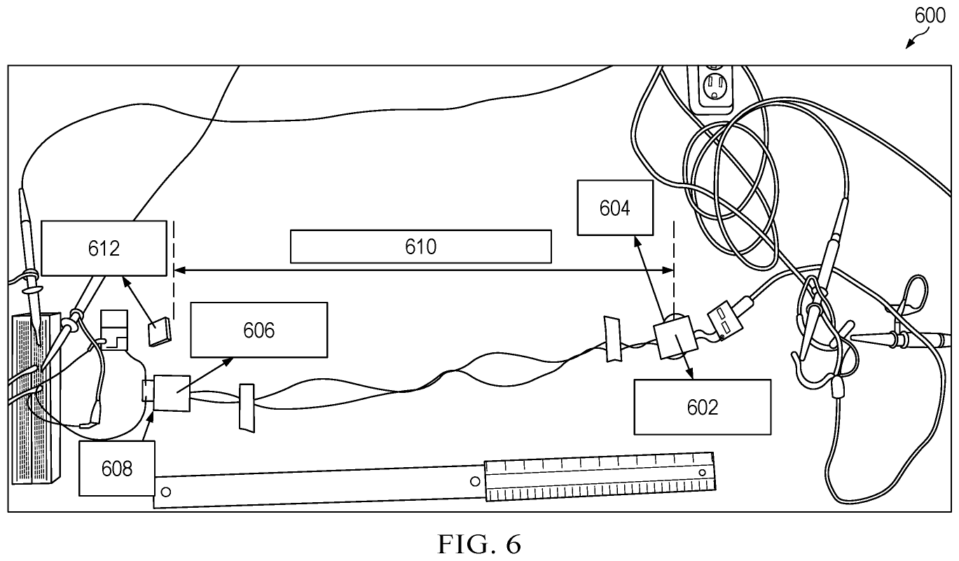

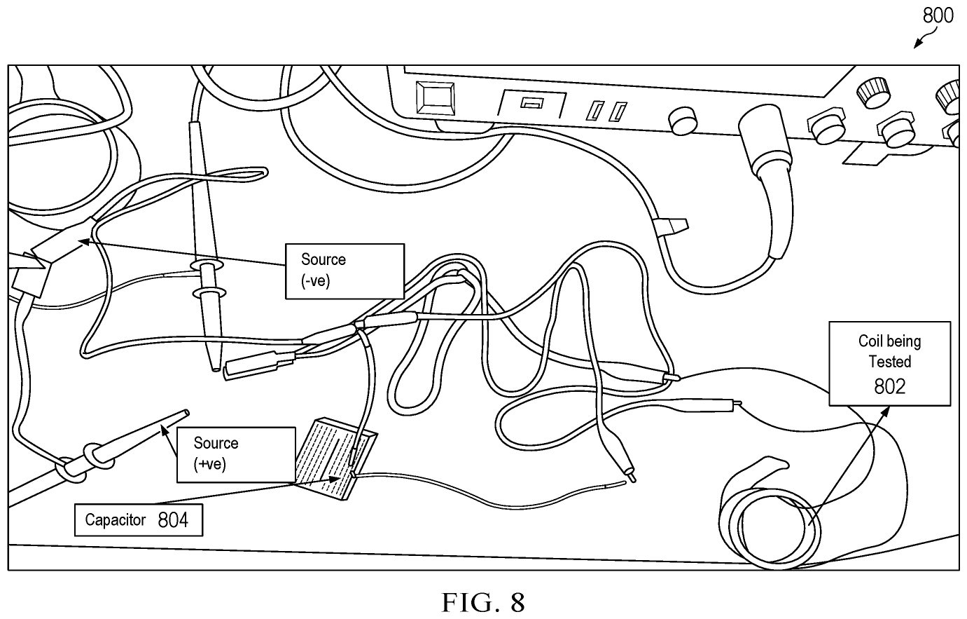

The experimental setup 300 was used to collect data on four different hardware setups:
Hardware Setup 1 (also referred to as Setup A or 300)—Loop coil 1 202 is placed on top of Tx coil 102, Loop coil 2 204 is placed on top of Rx coil 106, Tx coil 102 and Rx coil 106 are separated by approximately ten inches distance 304, and the coil diameter and number of turns were changed to different values:
Hardware Setup 2 (also referred to as Setup B or 500)—Loop coil 1 202 is placed on top of Tx coil 102, Loop coil 2 204 is placed on top of Rx coil 106, Tx coil 102 and Rx coil 106 are separated by more than twelve inches distance 502 as shown in FIG. 5, the coil diameter and number of turns were changed to different values, and three loop coils as well as three commercial coils (in a similar fashion) were connected in series in which one of them (intermediate passive (battery-less) loop 504) was not used for each experiment:
Hardware Setup 3 (also referred to as Setup C or 600, 700)—Commercial coil 1 602 is placed on top of Tx coil 604, Commercial coil 2 606 is placed on top of Rx coil 608, Tx coil 604 and Rx coil 608 are separated by more than thirty inches distance 610 as shown in FIG. 6, the coils were approximately 12 uH with 21 turns of coil, and a Lip battery 612 was connected as a load as shown in FIGS. 6 and 7; and
Hardware Setup 4 (also referred to as Setup D or 800)—An experimental setup was used to tune a passive loop coil (coil being tested 802) to 140 kHz as shown in FIG. 8, the commercial Qi coils 802 were resonated at 140 kHz, the capacitor 804 value was changed back and forth to set the tuning frequency to 140 kHz, and an oscilloscope was used to check the frequency parameter.

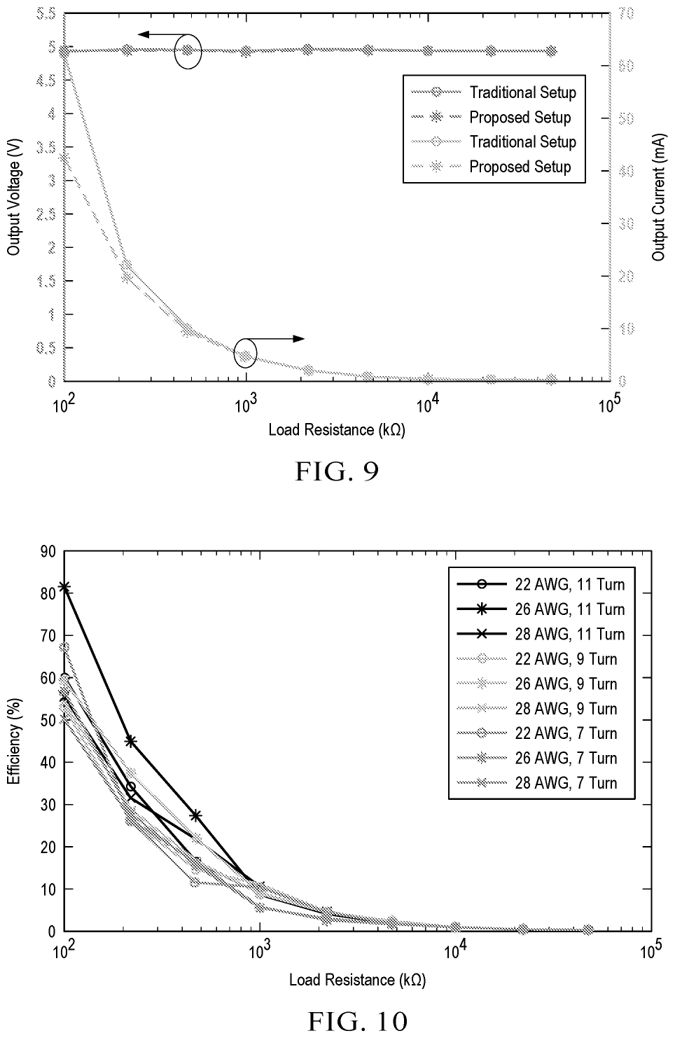

Now referring to FIG. 9, a graph showing output voltage and current achieved for traditional and proposed setups are shown. In the traditional setup, the GeekFun Tx coil 102 is placed over the Rx coil 106. In proposed setup as shown in FIGS. 3 and 4, the passive loop coils 202 and 204 have been placed between Tx coil 102 and Rx coil 106 with a separation of approximately 10 inches between them. The load resistance was varied from 100Ω to 47 kΩ. FIG. 4 represents the setup with 22 gauge loop coil with 11 turns for both of the loop coils. The same experiments have been done for 22, 26 and 28 gauge coils with 11, 9 and 7 turns. Also, the loop coils shape were similar to the Qi Tx and Rx coil. As depicted in FIG. 9, the pattern of output voltage and current values are almost identical even if the Tx and Rx coils 102, 104 are separated by a distance of 10 inches using the passive loop coils 202, 204.

Referring now to FIG. 10, the performance of the proposed setup with different coil size and number of turns is shown. The magnetic coil sizes used in the proposed setup were 22, 26 and 28 American wire gauge (AWG). For each of the different coil diameters, the number of turns were varied for 7, 9 and 11 turn respectively. The efficiency is better with lower load resistances compared to higher ones. As depicted in the FIG. 10, the overall performance of the efficiency is better when number of turn is increased to 11. Also, better efficiency is observed for greater coil diameter (22 AWG) compared to lower ones in case of 1 kΩ to 47 kΩ load resistances.

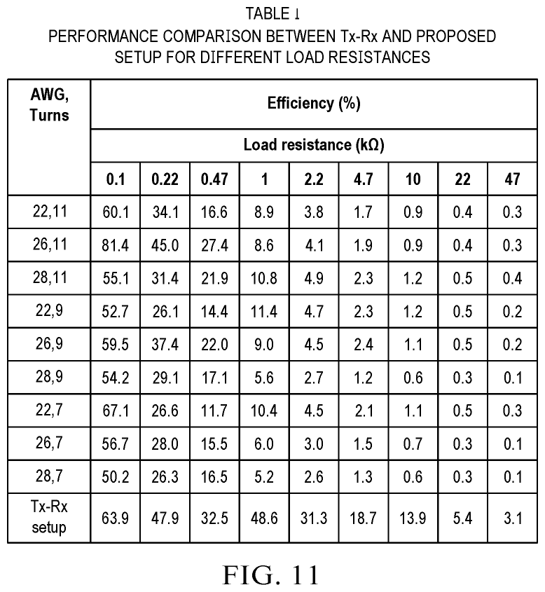

Table I (FIG. 11) presents the performance comparison between Tx-Rx and proposed setup for different load resistances. The Tx-Rx setup implements the GeekFun Tx and Rx traditionally placed on top of each other. The Tx-Rx setup offers greater efficiency, however the range is limited. The proposed setup offers longer-range power transfer with reasonable efficiency compared to Tx-Rx setup when the load resistances are lower.

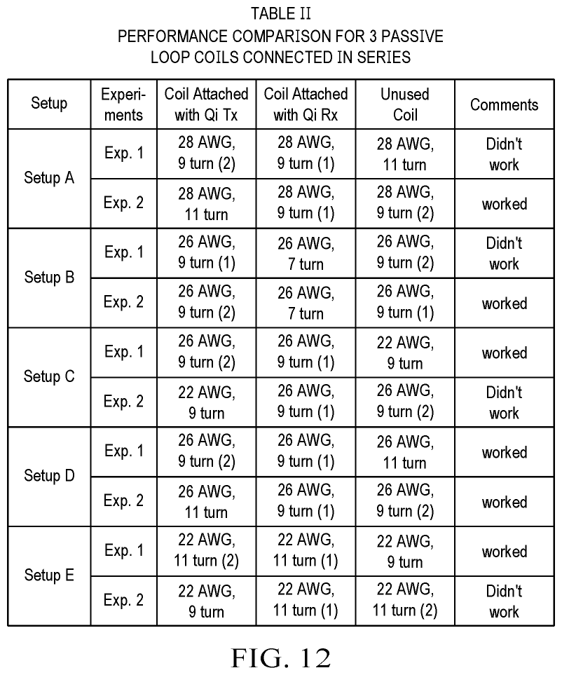

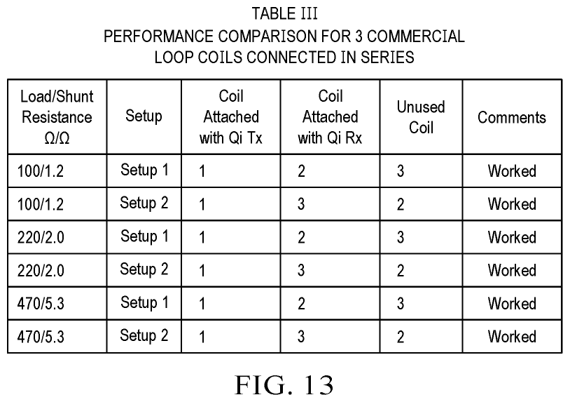

In previously described setup 2, three loop coils were connected in series. These three coils were both proposed loop coils and commercial coils. Tables II (FIG. 12) and III (FIG. 13) represent in which cases the three coil setup worked for passive loop coils and commercial coils respectively.

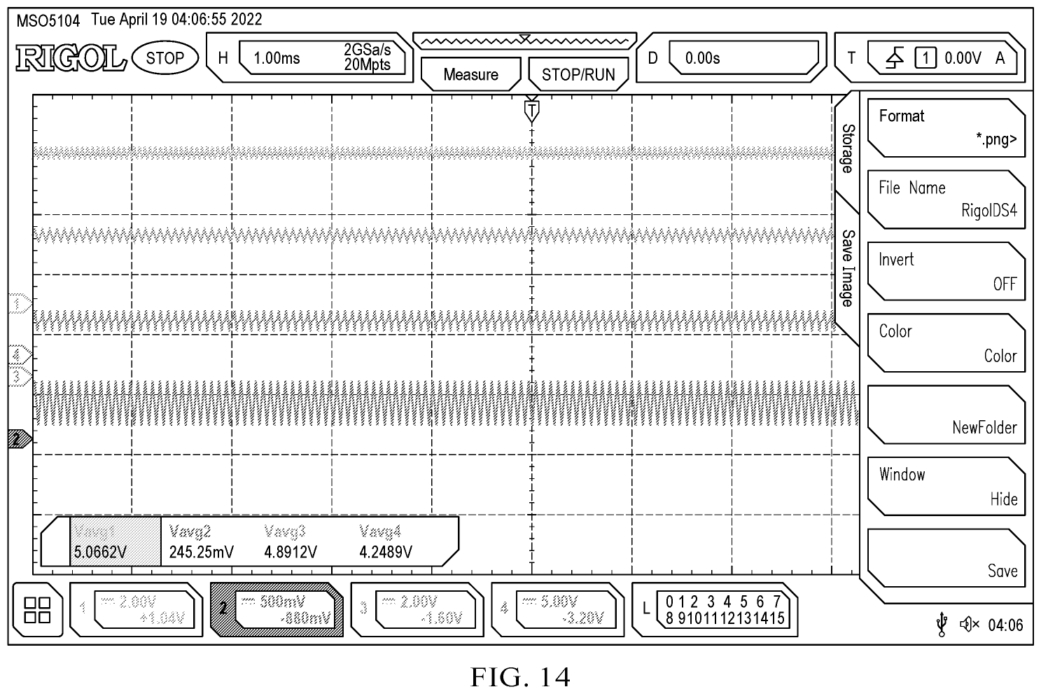

In previously described setup 3, a Lipo battery was charged using the proposed method of commercial coils connected in series. FIG. 14 shows the oscilloscope output, where Vavg1, Vavg2, Vavg3, Vavg4 is voltage across Tx side, 100Ω (Tx side), Rx side and lipo charger respectively.

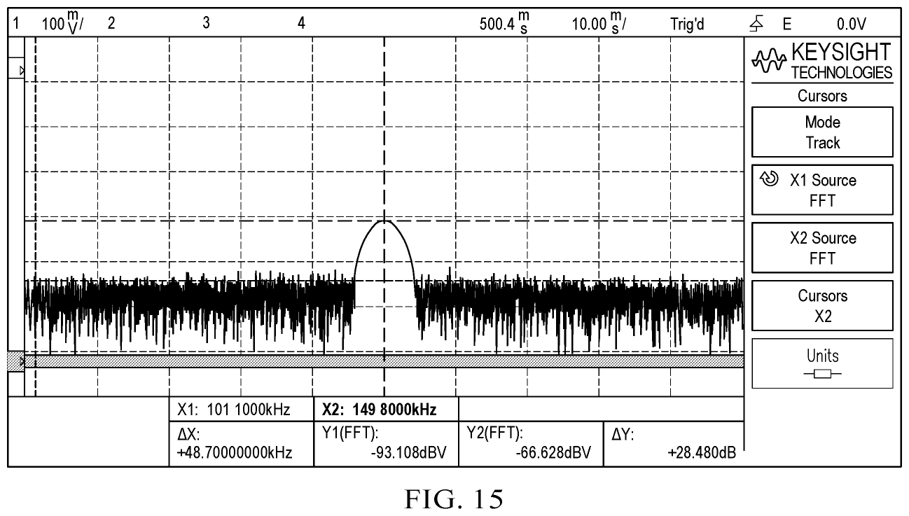

In previously described setup 4, FIG. 15 represents one of the tuning processes where three capacitors 47 nF, 4.7 nF and 10 nF were connected in parallel to tune the proposed loop coil to 140 kHz. The achieved resonant frequency observed in oscilloscope was 149.80 KHz.

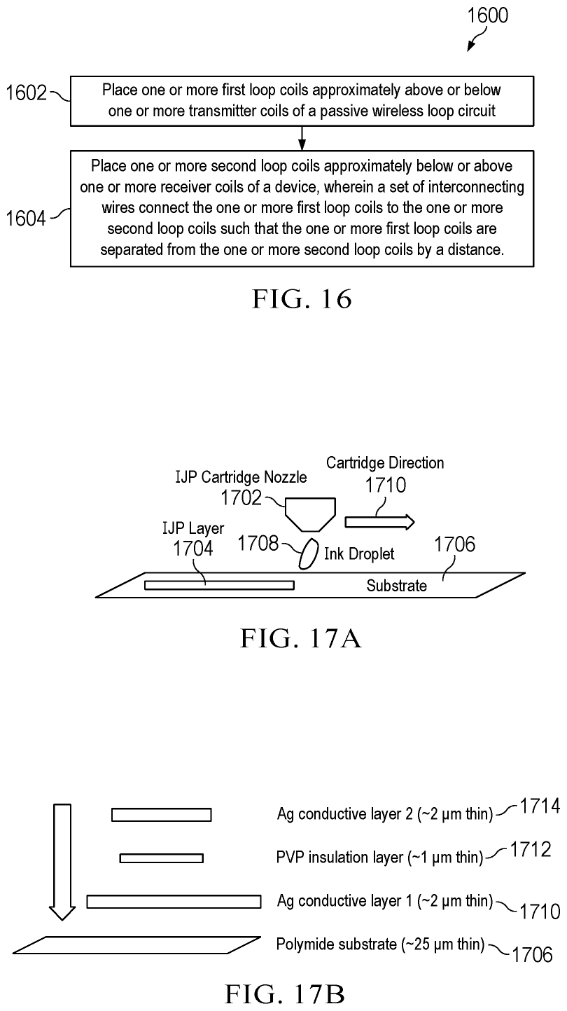

Now referring to FIG. 16, a method 1600 for extending a range of a passive wireless loop circuit is shown in accordance with one embodiment of the present invention. One or more first loop coils are placed approximately above or below a transmitter coil of the passive wireless loop circuit in block 1602. One or more second loop coils are placed approximately below or above a receiver coil of a device in block 1604, wherein a set of interconnecting wires series or parallel connect the one or more first loop coils to the one or more second loop coils such that the one or more first loop coils are separated from the one or more second loop coils by a distance.

In one aspect, the one or more first loop coils comprise one or more transmitter loop coils, and the one or more second loop coils comprise one or more receiver loop coils. In another aspect, a diameter of the one or more first loop coils or the one or more second loop coils are of the same size or different sizes (e.g., 22, 26, 28 AWG or any other AWG). In another aspect, a number of turns of the one or more first loop coils or the one or more second loop coils comprises 7, 9, 11, or any other number of turns. In another aspect, one or more tuning capacitors are connected to each of the one or more first loop coils and the one or more second loop coils. In another aspect, the method further comprises coupling one or more wireless transmitter circuits is coupled to the one or more transmitter coils, and coupling one or more wireless receiver circuits is coupled to the one or more receiver coils. In another aspect, the method further comprises powering the device using the one or more second loops coils, or charging a battery or energy storage element of the device using the one or more second loop coils. In another aspect, the device comprises a phone, a handheld device, a watch, a wearable device, a tablet, a computer, an instrument, a sensor, a consumer electronic product, a physical implant, an autonomous electric vehicle, or anything containing a battery or energy storage element or capable of being powered by the present invention.

A non-limiting example of a method for fabricating the loop coils will now be described. An Inkjet (IJP) fabrication process and the multilayer IJP fabrication are depicted in FIGS. 17A and 17B, respectively. FIG. 17A shows an IJP cartridge nozzle 1702 forming an IJP layer 1704 on substrate 1706 by depositing ink droplets 1708 in the cartridge direction 1710. FIG. 17B depicts the layers of one of the coils. Ag conductive layer 1 (approximately 2 μm thin) 1710 was printed on the polyimide substrate (approximately 25 μm thin) 1706. PVP insulation layer (approximately 1 μm thin) 1712 was printed on the Ag conductive layer 1 1710. Ag conductive layer 2 (approximately 2 μm thin) 1714 was printed on the PVP insulation layer 1712.

IJP coils were designed using Inkscape vector graphics software, then converted into printing format. Two sets of IJP loop coils were designed: one with 8 turns for both TX and RX side coils, and another with 10 turns for the TX side coil and 8 turns for the RX side coil. For both sets of loop coils, the distance between the transmitting and receiving side was 7 inches. For all silver (Ag) traces, the trace width was 1 mm and the gap between traces was 1 mm. The width and height for 8 turn coils were 34.7 mm and 37.6 mm, respectively. For 10 turn coils the width and height were 42.7 mm and 45.6 mm, respectively.

For conductive layer printing, Metalon JS-A191 (Novacentrix Inc., TX) silver ink was used for conductive layers 1710, 1714. JS-A191 ink contains 40% Ag nanoparticles by weight, where the Ag concentration is 25-50% with 10-15% ethylene glycol and 0.2-1% polyethylene glycol 4-(tert-octylphenyl) ether. For nonconductive layer printing, a custom made Poly (4-vinylphenol) (PVP) ink was used for the insulation layer 1712.

Dimatix Materials Printer (DMP-2850, Fuji-Film Inc.) were used for IJP fabrication. The substrate was 25 μm thin flexible polyimide (PI) film. For printing the loop coils, jetting voltage and jetting frequency of 31 V and 20 kHz were used, respectively for Ag layer 1710, 1714. For printing of PVP ink 1712, jetting voltage of 25 volts and 20 kHz for jetting frequency were used. IJP fabrication was performed with 15 μm drop spacing and 1693 dpi printing resolution.

Thermal curing of printed layers was performed using a Heratherm Oven (Thermo Fisher Scientific Inc., MA). Bottom Ag layers 1710 was cured at 250° C. for 30 minutes. Six coatings of PVP 1712 were printed on top of bottom Ag layer 1710 to make the insulation between top and bottom Ag layers 1714, 1710 respectively. Each time two coatings of PVP 1712 were printed and cured at 190° C. for 30 minutes. Finally, the top Ag layer 1714 was printed and cured at 190° C. for 30 minutes.

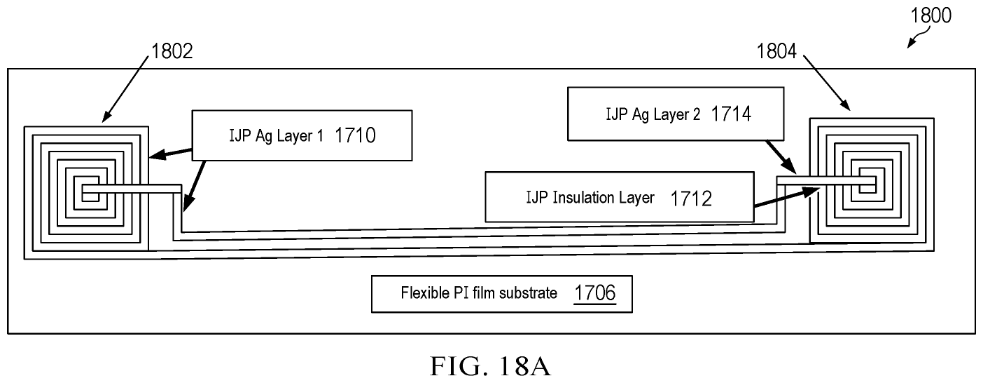

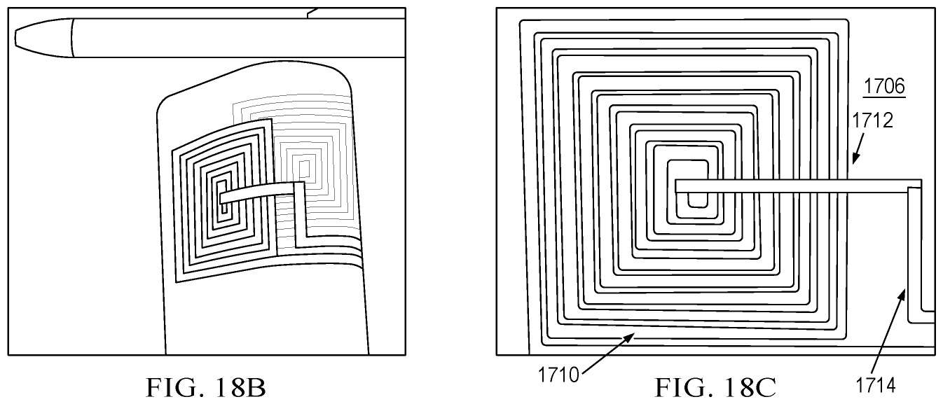

Now referring to FIG. 18A, a photograph of two ILP loop coils 1802 and 1804 on PI film 1706 is shown. FIG. 18B is a photograph showing a rolled up IJP loop coils showing flexibility. FIG. 18C is a microscope image showing details of the two IJP Ag layers 1710, 1714 and the insulation IJP PVP layer 1712 in between the two Ag layers 1710, 1714.

As the current in loop coil is dependent on its impedance, a lower impedance is preferred. But IJP Ag traces have higher impedance (than copper). Higher curing temperature and duration for IJP layer 1 of Ag were used to reduce overall impedance of the loop coils. For instance, using 180° C. heat for 15 minutes obtained 12.9 (resistance, 200° C. for 30 minutes resulted 5.9Ω, and 250° C. for 30 minutes produced 3.6Ω resistance for the case of 8 turns (both LC1 and LC2) loop coils. For IJP layer 2 of Ag, always a lower temperature and duration was used to prevent degradation of printed PVP layer.

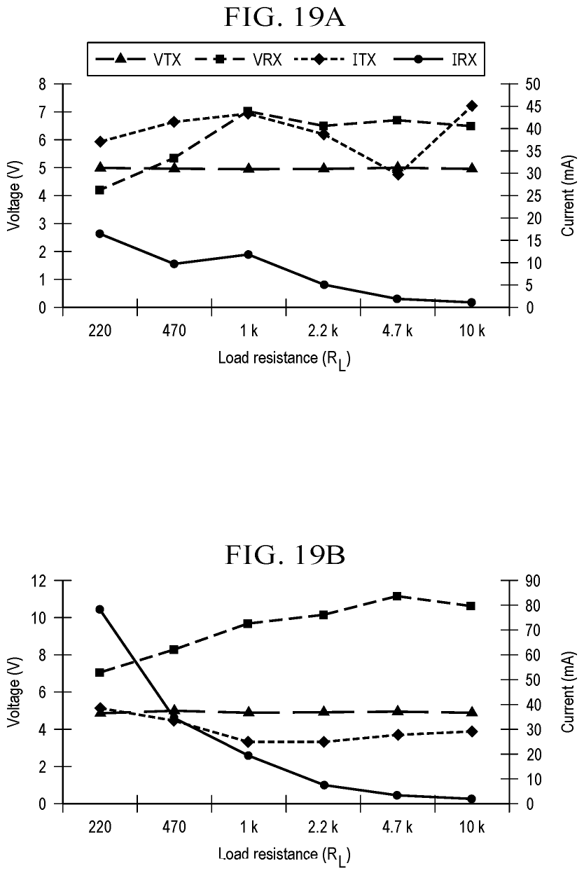

Referring now to FIGS. 19A and 19B, the results of power transfer for the 2 sets of coils are plotted: one with LC1=8 turns and LC2=8 turns (FIG. 18A), and another with LC1=10 turns and LC2=8 turns (FIG. 18B). Results demonstrate the receiver voltage is higher for higher Rz, while the receiver current decreases for higher RL. Maximum current of 80 mA was noted at 7 V for 220Ω in FIG. 18 (b).

The experiment described above demonstrates that flexible IJP loop coils, with <50 μm thickness, can be used for wireless power transfer at a large distance. This technique might be useful for powering implantable and wearable devices for medical applications.

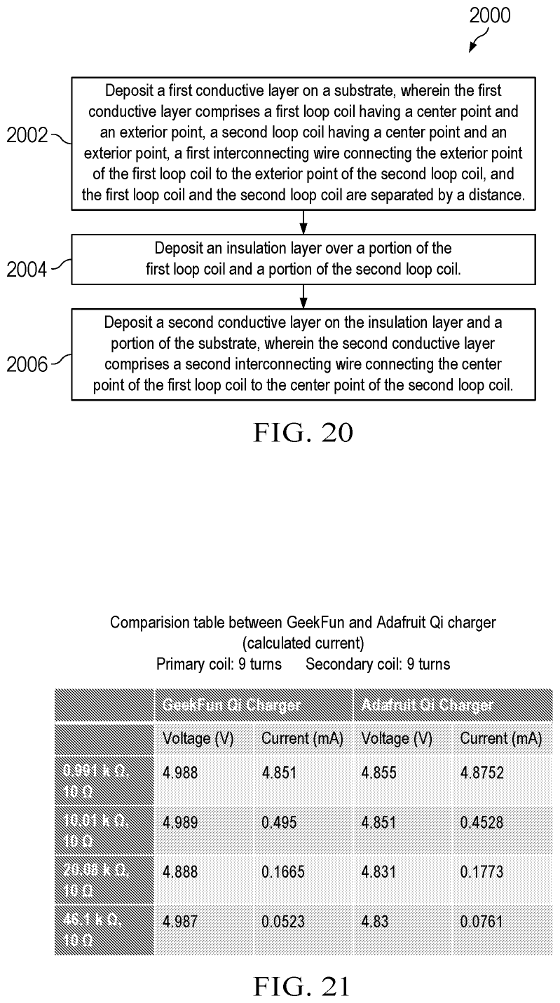

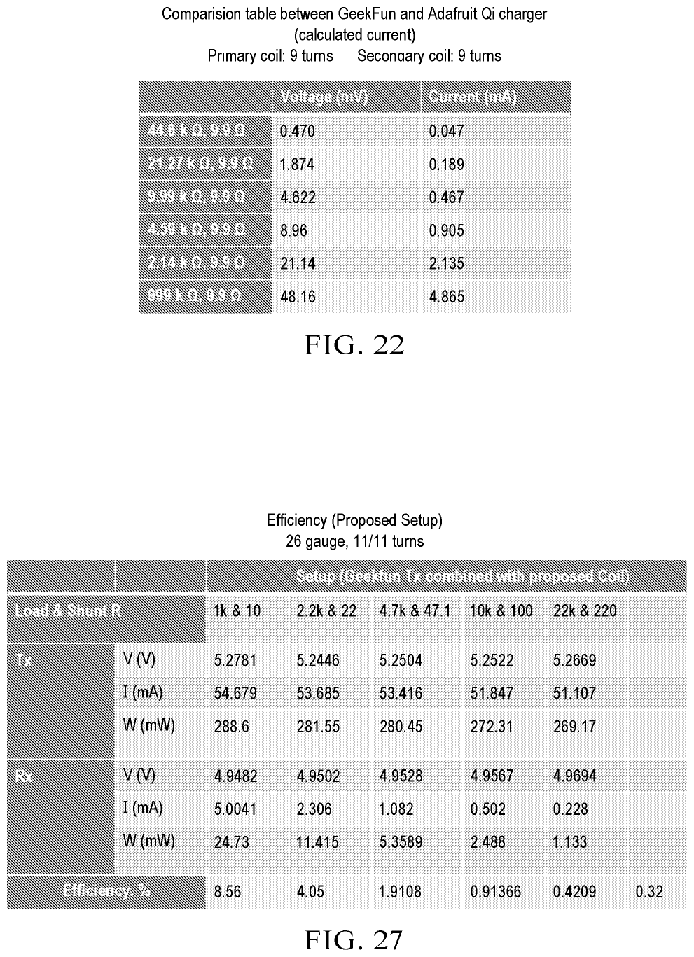

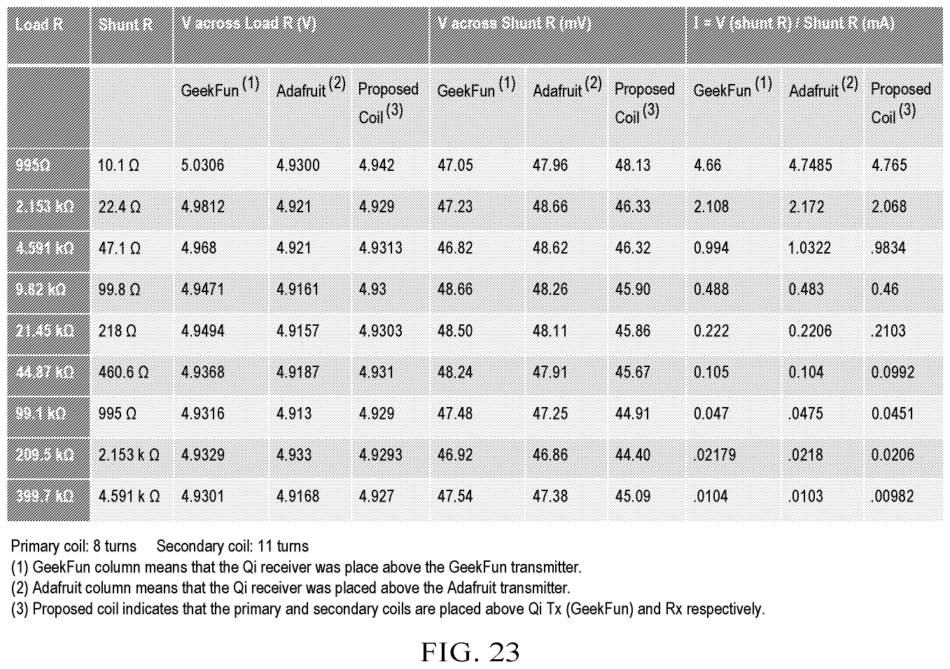

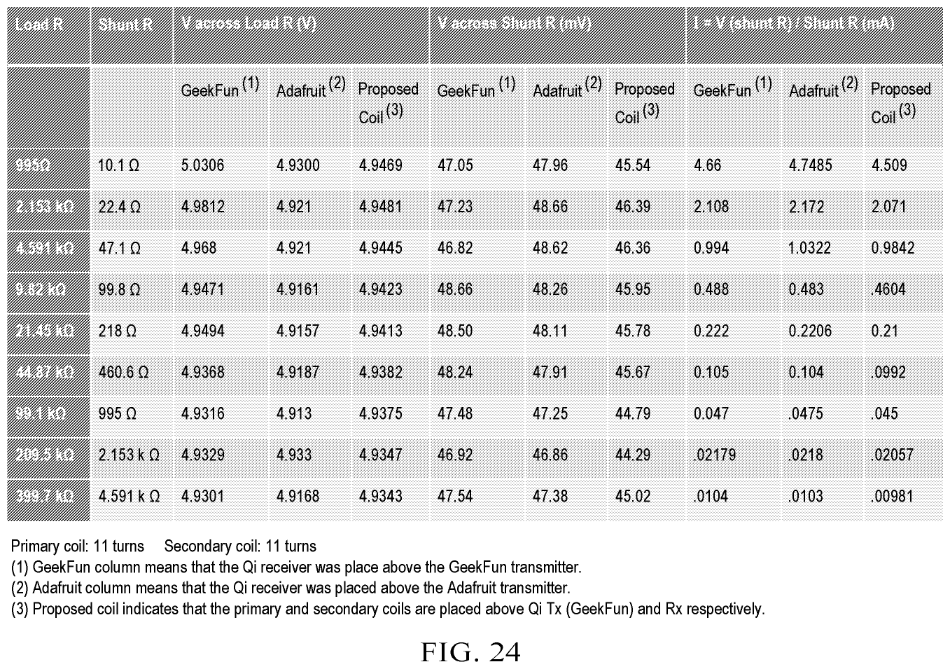

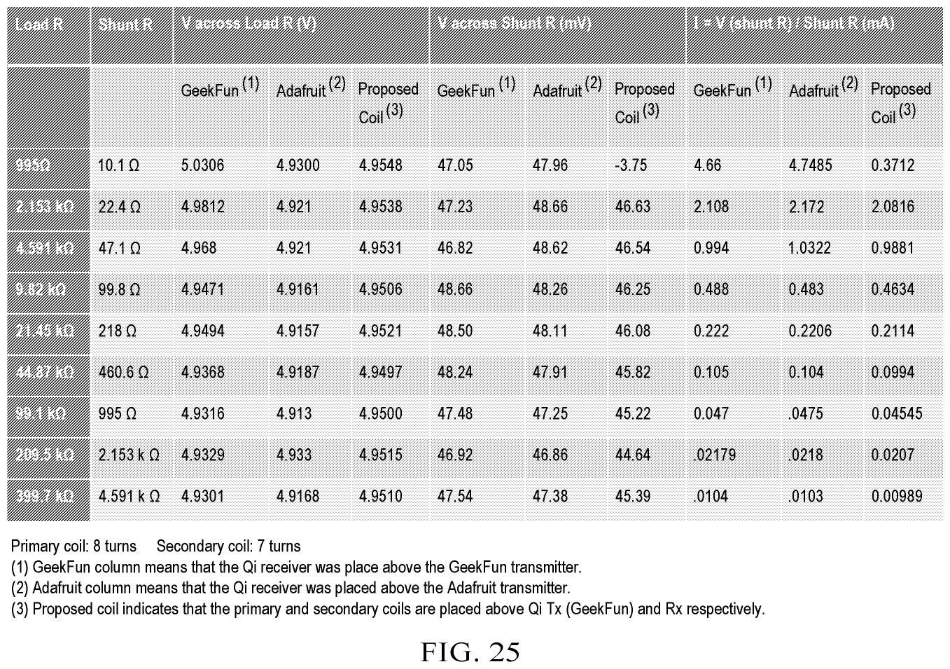

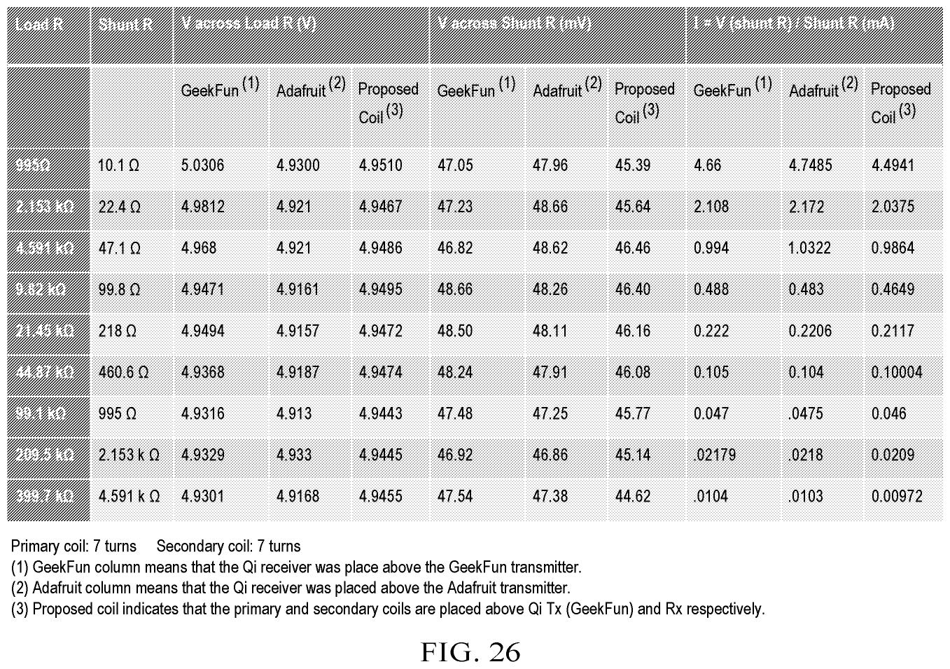

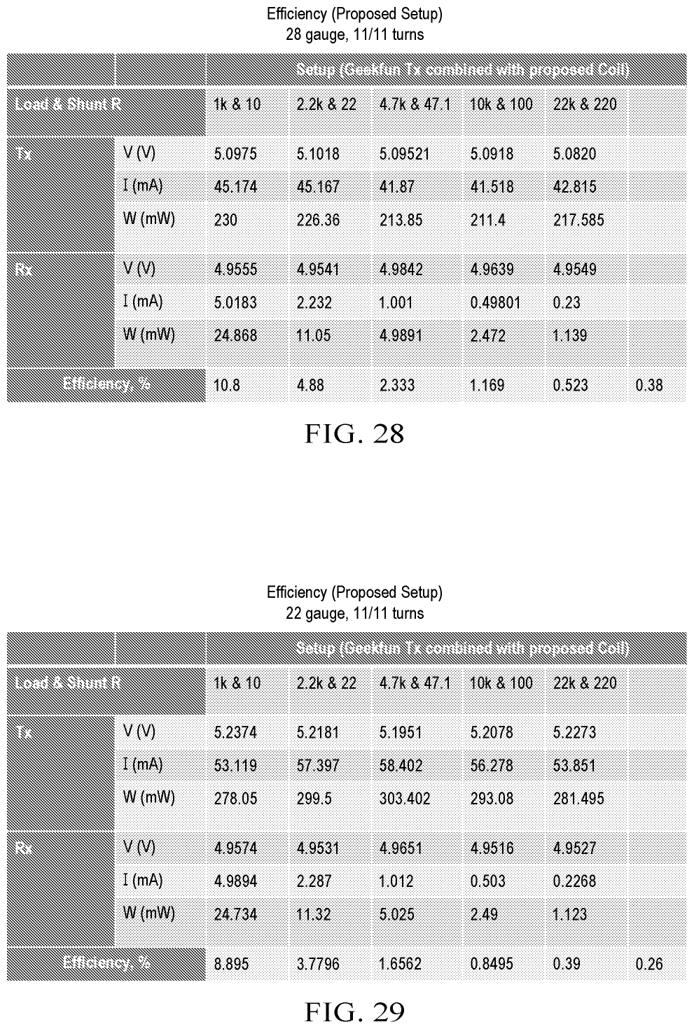

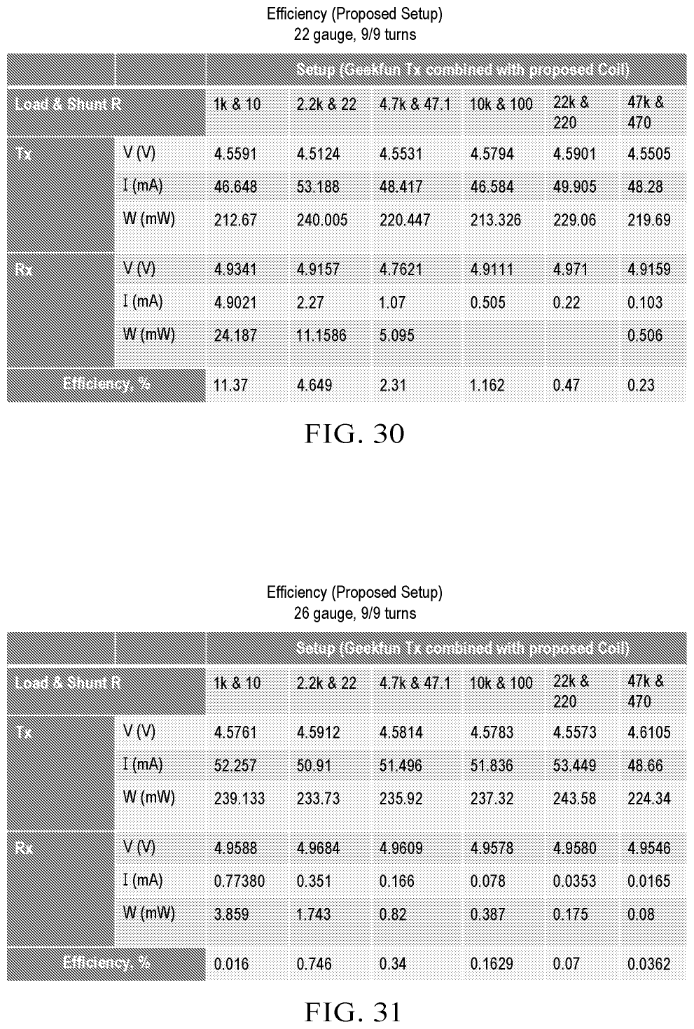

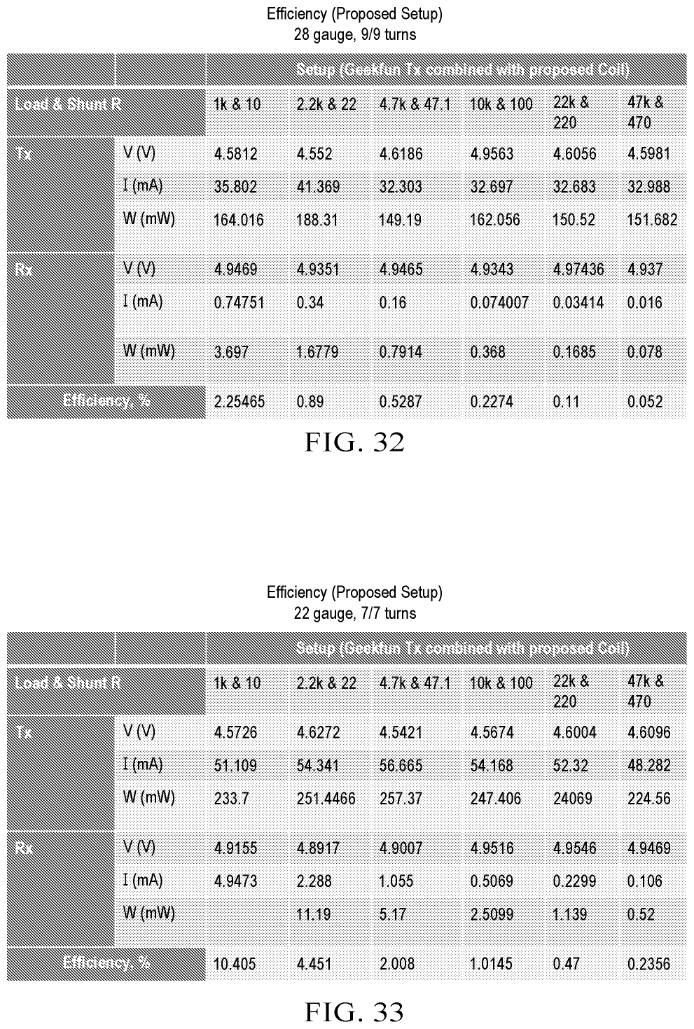

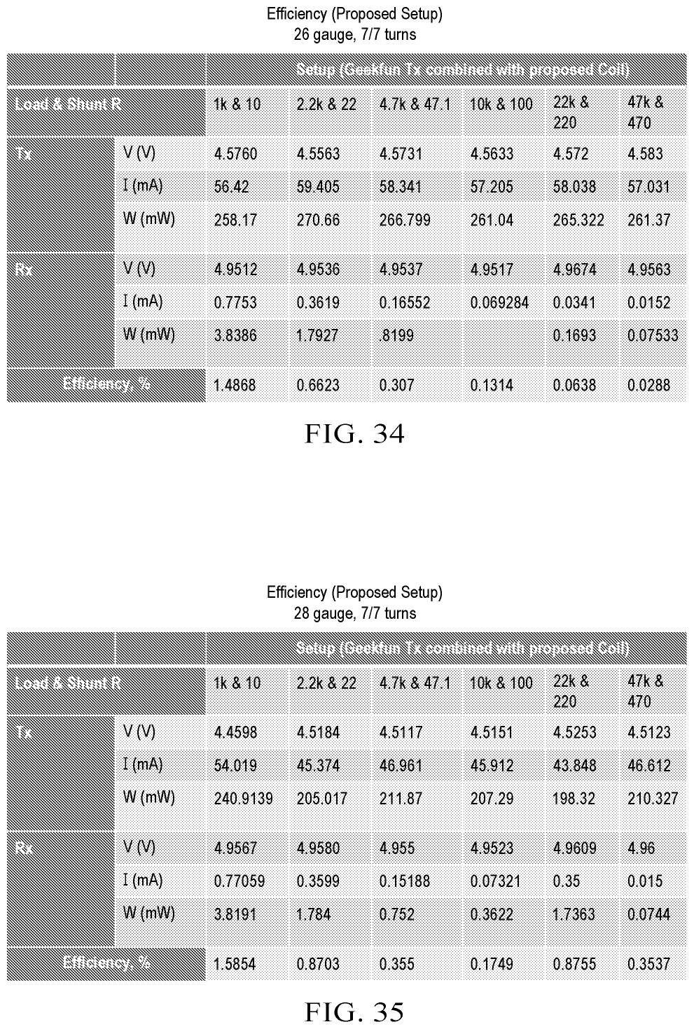

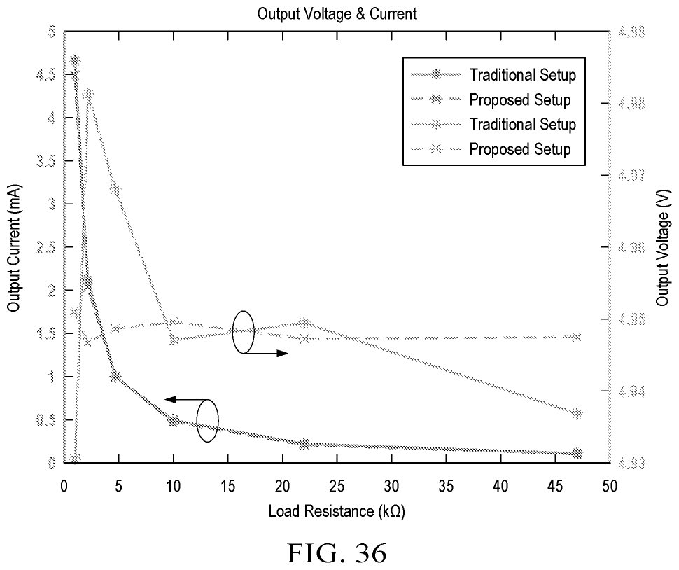

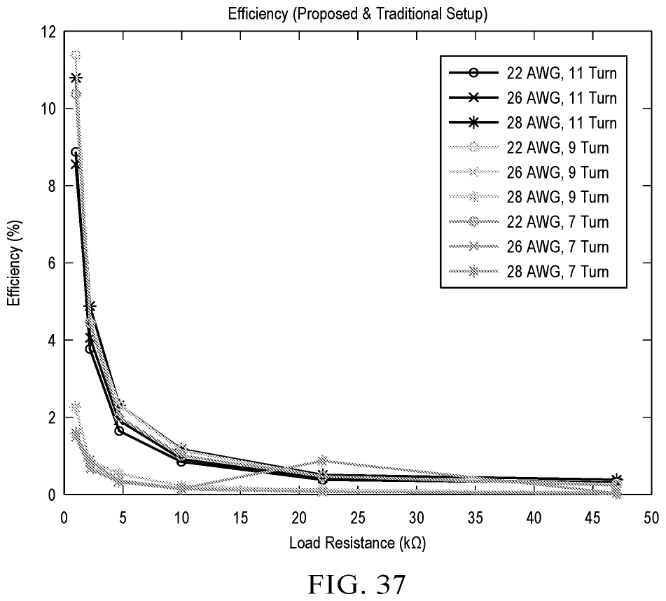

Now referring to FIG. 20, a flow chart of a method 2000 for printing a passive wireless loop circuit in accordance with one embodiment of the present invention is shown. A first conductive layer is deposited on a substrate in block 2002. The first conductive layer comprises a first loop coil having a center point and an exterior point, a second loop coil having a center point and an exterior point, a first interconnecting wire connecting the exterior point of the first loop coil to the exterior point of the second loop coil, and the first loop coil is separated from the second loop coil by a distance. An insulation layer is deposited over a portion of the first loop coil and a portion of the second loop coil in block 2002. A second conductive layer is deposited on the insulation layer and a portion of the substrate in block 2004. The second conductive layer comprises a second interconnecting wire connecting the center point of the first loop coil to the center point of the second first loop coil.

In one aspect, the method is performed using an Inkjet printer. Note that other manufacturing processes can be used. In another aspect, the substrate is flexible. In another aspect, the method further comprises curing the first conductive layer; curing the insulation layer; and curing the second conductive layer. In another aspect, the method further comprises depositing a protective layer over the first conductive layer, the insulation layer or the second conductive layer. In another aspect, a trace for the first and second conductive layers is approximately 1 mm wide with a gap of approximately 1 mm between adjacent traces. In another aspect, the insulation layer comprises one or more coatings of an insulation material. In another aspect, the method further comprises curing the insulation layer after each deposit of the one or more coatings of the insulation material. In another aspect, the intermediate passive wireless loop circuit has a thickness of less than 50 μm.

In another embodiment of the present invention, an intermediate passive wireless loop circuit fabricated in accordance with the method described above.

Additional data regarding the present invention is shown in FIGS. 21 to 37.

As demonstrated above, various embodiments of the present invention increase the range of WPT systems by implementing wireless passive loop coil. The proposed method for specific coil diameter and number of turns, can offer reasonably identical output voltage and current as like as traditional setup. By using the proposed method, the distance between Qi Tx coil and Rx coil can be extended by 10 inches or more. Although the experiments demonstrated two coils in series, other embodiments of the present invention are not limited to two coils. Moreover, the two coils can be connected in parallel. One or more tuning capacitors can be used improve the power efficiency by providing resonant coupling. The proposed method can be useful in power transfer for wearable, consumer electronic products, physical implants or for autonomous electric vehicles.

It will be understood that particular embodiments described herein are shown by way of illustration and not as limitations of the invention. The principal features of this invention can be employed in various embodiments without departing from the scope of the invention. Those skilled in the art will recognize or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited features, elements, components, groups, integers, and/or steps, but do not exclude the presence of other unstated features, elements, components, groups, integers and/or steps. In embodiments of any of the compositions and methods provided herein, “comprising” may be replaced with “consisting essentially of” or “consisting of”. As used herein, the term “consisting” is used to indicate the presence of the recited integer (e.g., a feature, an element, a characteristic, a property, a method/process step or a limitation) or group of integers (e.g., feature(s), element(s), characteristic(s), property (ies), method/process steps or limitation(s)) only. As used herein, the phrase “consisting essentially of” requires the specified features, elements, components, groups, integers, and/or steps, but do not exclude the presence of other unstated features, elements, components, groups, integers and/or steps as well as those that do not materially affect the basic and novel characteristic(s) and/or function of the claimed invention.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skill in the art recognize the modified feature as still having the required characteristics and capabilities of the unmodified feature. In general, but subject to the preceding discussion, a numerical value herein that is modified by a word of approximation such as “about” may vary from the stated value by at least #1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

To aid the Patent Office, and any readers of any patent issued on this application in interpreting the claims appended hereto, applicants wish to note that they do not intend any of the appended claims to invoke paragraph 6 of 35 U.S.C. § 112, U.S.C. § 112 paragraph (f), or equivalent, as it exists on the date of filing hereof unless the words “means for” or “step for” are explicitly used in the particular claim.

For each of the claims, each dependent claim can depend both from the independent claim and from each of the prior dependent claims for each and every claim so long as the prior claim provides a proper antecedent basis for a claim term or element.

### REFERENCES

1. K. Lee, J. Kim and C. Cha, “Microwave-based Wireless Power Transfer using Beam Scanning for Wireless Sensors,” IEEE EUROCON 2019-18th International Conference on Smart Technologies, 2019, pp. 1-5, doi: 10.1109/EUROCON.2019.8861838.
2. K. J. Duncan, “Laser based power transmission: Component selection and laser hazard analysis,” 2016 IEEE PELS Workshop on Emerging Technologies: Wireless Power Transfer (WoW), 2016, pp. 100-103, doi: 10.1109/WoW.2016.7772073.
3. S. K. Samal, D. P. Kar, P. K. Sahoo, S. Bhuyan and S. N. Das, “Analysis of the effect of design parameters on the power transfer efficiency of resonant inductive coupling based wireless EV charging system,” 2017 Innovations in Power and Advanced Computing Technologies (i-PACT), 2017, pp. 1-4, doi: 10.1109/IPACT.2017.8245034.
4. S. Chen, J. Xiao, Q. Chen, X. Wu and W. Gong, “Re-search on Magnetic Integration Coupling Mechanism of UAV Wire-less Power Transfer System,” 2021 IEEE 16th Conference on Indus-trial Electronics and Applications (ICIEA), 2021, pp. 1007-1010, doi: 10.1109/ICIEA51954.2021.9516415.
5. T. Sun, X. Xie, and Z. Wang, “Wireless Power Transfer for Medical Microsystems”, Springer Science, 2013.
6. R. Mahajan, B. I. Morshed, and G. M. Bidelman, “BRAINsens: Bodyworn Reconfigurable Architecture of Integrated Network Sensors”, Journal of Medical Systems, vol. 42, no. 185, pp. 1-14, October 2018.
7. M. Rahman and B. I. Morshed, “Estimation of Respiration Rate using an Inertial Measurement Unit Placed on Thorax-Abdomen,” 2021 IEEE International Conference on Electro Information Technology (EIT), 2021, pp. 1-5, doi: 10.1109/EIT51626.2021.9491900.
8. T. Campi, S. Cruciani, F. Maradei and M. Feliziani, “Wireless Power Supply System for Left Ventricular Assist Device and Implanted Cardiac Defibrillator,” 2021 IEEE Wireless Power Transfer Conference (WPTC), 2021, pp. 1-4, doi: 10.1109/WPTC51349.2021.9458163.
9. Y. Li, Y. Wang, Y. Cheng, X. Li and G. Xing, “QiLoc: A Qi wire-less charging based system for robust user-initiated indoor location services,” 2015 12th Annual IEEE International Conference on Sensing, Communication, and Networking (SECON), 2015, pp. 480-488, doi: 10.1109/SAHCN.2015.7338349.
10. S. M. Kim, I. K. Cho, S. W. Kim, J. I. Moon, and H. J. Lee, “A qi-compatible wireless charging pocket for smartphone”, IEEE Wireless Power Transfer Conference, pp. 387-390, 2020.
11. J. Xiao, E. Cheng, N. Cheung, B. Zhang and J. F. Pan, “Study of wireless charging lane for electric vehicles,” 2016 International Symposium on Electrical Engineering (ISEE), 2016, pp. 1-4, doi: 10.1109/EENG.2016.7845989.
12. P. Marks, “Wireless charging for electric vehicles hits the road”, New Scientist, January 2014.
13. B. Noroozi, and B. I. Morshed, “PSC Optimization of 13.56 MHz Resistive Wireless Analog Passive Sensors”, IEEE Trans Microwave Theory and Techniques, vol. 65, no. 9, pp. 3548-3555 September 2017.
14. J. Jadidian and D. Katabi, “Magnetic MIMO: How to charge your phone in your pocket”, Proceedings of the Annual International Conference on Mobile Computing and Networking, MOBICOM, pp. 495-506, 2014.
15. A. Mohapatra, S. K. Tuli, K. Liu, T. Fujiwara, R. W. Hewitt Jr., F. Andrasik, and B. I. Morshed. “Inkjet Printed Parallel Plate Capacitors Using PVP Polymer Dielectric Ink on Flexible Polyimide Substrates”, IEEE Engineering in Med. and Biol. Conf. (EMBC), pp. 4277-4280, 2018.

1. An intermediate passive wireless loop circuit, comprising:
one or more first loop coils;
one or more second loop coils; and
a set of interconnecting wires that series or parallel connect the one or more first loop coils to the one or more second loop coils such that the one or more first loop coils are separated from the one or more second loop coils by a distance.

2. The intermediate passive wireless loop circuit of claim 1, wherein the one or more first loop coils comprise one or more transmitter loop coils, and the one or more second loop coils comprise one or more receiver loop coils.

3. The intermediate passive wireless loop circuit of claim 1, wherein a diameter of the one or more first loop coils or the one or more second loop coils are of the same size or different sizes.

4. The intermediate passive wireless loop circuit of claim 1, wherein a number of turns of the one or more first loop coils or the one or more second loop coils comprises any number of turns.

5. The intermediate passive wireless loop circuit of claim 1, further comprising one or more tuning capacitors connected to each of the one or more first loop coils and the one or more second loop coils.

6. The intermediate passive wireless loop circuit of claim 1, wherein:
the one or more first loop coils or the one or more second loop coils power a device; or
the one or more first loop coils or the one or more second loop coils charge a battery or energy storage element of the device.

7. The intermediate passive wireless loop circuit of claim 6, wherein the device comprises a phone, a handheld device, a watch, a wearable device, a tablet, a computer, an instrument, a sensor, a consumer electronic product, a physical implant, or an autonomous electric vehicle.

8. A method for extending a range of a passive wireless loop circuit, the method comprising:
placing one or more first loop coils approximately above or below one or more transmitter coils of the passive wireless loop circuit;
placing one or more second loop coils approximately below or above one or more receiver coils of a device; and
wherein a set of interconnecting wires series or parallel connect the one or more first loop coils to the one or more second loop coils such that the one or more first loop coils are separated from the one or more second loop coils by a distance.

9. The method of claim 8, wherein the one or more first loop coils comprise one or more transmitter loop coils, and the one or more second loop coils comprise one or more receiver loop coils.

10. The method of claim 8, wherein a diameter of the one or more first loop coils or the one or more second loop coils are of the same size or different sizes.

11. The method of claim 8, wherein a number of turns of the one or more first loop coils or the one or more second loop coils comprises any number of turns.

12. The method of claim 8, wherein one or more tuning capacitors are connected to each of the one or more first loop coils and the one or more second loop coils.

13. The method of claim 8, further comprising:
coupling one or more wireless transmitter circuits to the one or more transmitter coils; and
coupling one or more wireless receiver circuits to the one or more receiver coils.

14. The method of claim 8, further comprising:
powering the device using the one or more second loops coils; or
charging a battery or energy storage element of the device using the one or more second loop coils.

15. (canceled)

16. A system comprising:
one or more transmitter coils;
one or more first loop coils approximately above or below the transmitter coil;
one or more receiver coils;
one or more second loop coils approximately below or above the one or more receiver coils; and
a set of interconnecting wires that series or parallel connect the one or more first loop coils to the one or more second loop coils such that the one or more first loop coils are separated from the one or more second loop coils by a distance.

17-22. (canceled)

23. The system of claim 16, further comprising:
one or more wireless transmitter circuits coupled to the one or more transmitter coils; and
one or more wireless receiver circuits coupled to the one or more receiver coils.

24. The system of claim 23, wherein the wireless receiver circuit is coupled to a battery or energy storage element of the device.

25. A method for fabricating an intermediate passive wireless loop circuit, comprising:
depositing a first conductive layer on a substrate, wherein the first conductive layer comprises a first loop coil having a center point and an exterior point, a second loop coil having a center point and an exterior point, a first interconnecting wire connecting the exterior point of the first loop coil to the exterior point of the second loop coil, and the first loop coil is separated from the second loop coil by a distance;
depositing an insulation layer over a portion of the first loop coil and a portion of the second loop coil; and
depositing a second conductive layer on the insulation layer and a portion of the substrate, wherein the second conductive layer comprises a second interconnecting wire connecting the center point of the first loop coil to the center point of the second first loop coil.

26. The method as recited in claim 25, wherein the method is performed using an Inkjet printer.

27. The method as recited in claim 25, wherein the substrate is flexible.

28. The method as recited in claim 25, further comprising:
curing the first conductive layer;
curing the insulation layer; and
curing the second conductive layer.

29. The method as recited in claim 25, further comprising depositing a protective layer over the first conductive layer, the insulation layer or the second conductive layer.

30. The method as recited in claim 25, wherein a trace for the first and second conductive layers is approximately 1 mm wide with a gap of approximately 1 mm between adjacent traces.

31. The method as recited in claim 25, wherein the insulation layer comprises one or more coatings of an insulation material.

32. The method as recited in claim 31, further comprising curing the insulation layer after each deposit of the one or more coatings of the insulation material.

33. The method as recited in claim 25, wherein the intermediate passive wireless loop circuit has a thickness of less than 50 μm.

34. An intermediate passive wireless loop circuit fabricated in accordance with claim 25.
